(19) United States
(12) Patent Application Publication
(10) Pub. No.: US 2009/0118998 A1
(43) Pub. Date: May 7, 2009

(54) Flight Tracking Display Systems and Methods

(75) Inventors: Terry Chau, Newton, MA (US); Lorraine Flynn, Newton, MA (US); Mary Flynn, Newton, MA (US); James Steinberg, Melrose, MA (US); Michael H. Benjamin, Dover, MA (US); Everette Jordan, Needham, MA (US)

Correspondence Address: BROMBERG & SUNSTEIN LLP, 125 SUMMER STREET, BOSTON, MA, 02110-1618, US

(73) Assignee: FLIGHTVIEW INC., Allston, MA (US)

(21) Appl. No.: 12/267,276

(22) Filed: Nov. 7, 2008

Related U.S. Application Data
(60) Provisional application No. 60/986,076, filed on Nov. 7, 2007.

(51) Int. Cl. G06G 7/76; G06Q 30/00

(52) U.S. Cl. 701/120; 705/14

(57) ABSTRACT

A computer-based method of displaying real time flight information for aircraft. includes retrieving data previously stored for which there is real time flight information and causing display, on a screen of a client computing device, automatically and repetitively of a plurality of views of a geographic map. Such views collectively display all viewable flights in a pre-specified category. The embodiment additionally includes causing display simultaneously on the screen of the client computing device, with the geographic map, of a list of flights in the pre-specified category. The list scrolls automatically at least to the extent necessary to cause repetitive display of the entire list. Additionally, contents of the list are coordinated with each of the views.

### CROSS REFERENCE TO RELATED APPLICATIONS

The present application claims priority from U.S. Provisional Patent Application Ser. No. 60/986,076, filed Nov. 7, 2007, which is hereby incorporated by reference herein in its entirety.

### TECHNICAL FIELD

The present invention relates to real time tracking of aircraft, and more particularly to systems and methods for display of real time flight tracking data.

### BACKGROUND ART

Over a period of many years, we have developed and enhanced technology for the real-time display of aircraft flight data. Although real-time display of aircraft flight data is now well known, there are challenges in usefully presenting information within the plethora of data available, for example, from the FAA, to enable a user to find information that is pertinent. Typical solutions in the prior art include providing, at a terminal to which the user has access, a filter by which the user may select for display, on a map, flights, for example, of a single airline or of a specified flight between two cities, or departures or arrivals from an airport.

It is known in the prior art to establish a computer-based real time display of a flight on a map in a flight following-mode where the map moves under the displayed flight. It is known in the prior art to establish a computer-based real time display of flight information on a map, allowing the user to initiate zoom and pan commands, and to list flight information on a screen or browser. We previously developed a large format airport display providing a map, with a random zoom feature, with icons indicating flights arriving at an airport using dedicated client software running in a personal computer environment.

### SUMMARY OF THE INVENTION

In a first embodiment of the invention there is provided a computer-based method of displaying real time flight information for aircraft. In this embodiment, the method includes retrieving data previously stored for which there is real time flight information. The method also includes causing display, on a screen of a client computing device, automatically and repetitively of a plurality of views of a geographic map. Each view is overlaid with a group of icons corresponding to a group of flights in a pre-specified category for which there is real time flight information. The locations of the icons on the map correspond to locations for such flights based on real time flight information, and each view is associated with a distinct criterion for display of flights therein. Additionally, the pre-specified category is associated with a flight attribute or a geographic area in which such flights are present, and such views collectively display all viewable flights in the pre-specified category.

In a further related embodiment, the embodiment additionally includes causing display simultaneously on the screen of the client computing device, with the geographic map, of a list of flights in the pre-specified category. The list scrolls automatically at least to the extent necessary to cause repetitive display of the entire list. Additionally, contents of the list are coordinated with each of the views.

In a further related embodiment, each icon in the set of icons includes at least one of an airline abbreviation and an airline logo, and the method further includes causing display simultaneously on the screen of the client computing device, with the geographic map and the list, of a legend correlating airline name with at least one of airline abbreviation and airline logo.

Alternatively or in addition, each of the set of icons includes a textual component, and causing display of the map overlaid with the set of icons includes placing each of the textual components on the map in such a way as to at least usually avoid obscuring any other of the textual components.

Alternatively or in addition, the placing of the textual components on the map is done in such a way as to avoid obscuring any other icons and textual components by using the destination or departure airport and the air-traffic patterns to and from the said airport.

Also alternatively or in addition, these aspects may be included: (i) causing display of the list of flights pertinent to the area includes displaying flights in progress in the area; (ii) causing display of the list of flights pertinent to the area includes displaying flights that have recently landed; (iii) causing display of the list of flights pertinent to the area includes displaying scheduled flights that are not yet in air; or (iv) causing the map to be displayed automatically and repetitively among a plurality of views so as to repetitively cover a plurality of geographic regions, the views collectively displaying all flights in progress in the geographic regions.

Optionally, with respect to aspect (iv), a plurality of airlines have flights arriving at an airport, causing the map to be displayed automatically and repetitively among a plurality of views includes causing the map to cycle through successive views, with each view relating to a distinct group of airlines having flights arriving at the airport.

Optionally, with respect to aspect (iv), causing the map to be displayed automatically and repetitively among a plurality of views includes causing the map to cycle through successive views associated with distinct facilities.

Optionally, with respect to aspect (iv), the distinct facilities are selected from the group consisting of airports and terminals.

Optionally, with respect to aspect (iv), causing the map to be displayed automatically and repetitively among a plurality of views includes causing at least one of zooming or panning of the map. As a further option, causing the map to be displayed automatically and repetitively among a plurality of views includes causing both zooming and panning of the map.

In yet another variant of the embodiment described herein, display of the list includes changing the contents of the list synchronously with views of the map so that flights for which icons are shown on a view of the map simultaneously appear on the list.

Alternatively or in addition, the list includes all flights in progress arriving at an airport.

Alternatively or in addition, the list includes all flights in progress of a plurality of airlines having flights arriving at an airport. Optionally, the list is sorted by airline, and the list is arranged so that the list scrolls automatically through the arriving flights of a first airline before scrolling through any of the arriving flights of another airline.

Alternatively or in addition, the list includes flights in progress arriving at a plurality of locations, the list arranged so that the list scrolls automatically through the arriving flights of a first location before scrolling through any of the arriving flights of another location. Optionally, each of the locations is a distinct terminal of an airport. Alternatively, each of the locations is a distinct airport, and the airports are located near one another.

Alternatively or in addition, the list includes flights arriving at a terminal of an airport.

Also alternatively or in addition, the embodiment includes in response to a user input to the client computing device as to a desired criterion in display of flight information, using the criterion in causing display of flight information. Optionally, the user input is an interrupt command, operative on the display automatically and repetitively of the plurality of views, and using the criterion includes freezing a selected view being displayed. As a further embodiment, the method also includes providing a user input for selecting a flight of interest, and in response to the user input selecting a flight of interest, causing display of details concerning the flight of interest. Optionally, the user input for selecting the flight of interest also provides the interrupt command.

Alternatively or in addition, the method also includes causing display of at least one of an advertisement and a notification on the screen of the client computing device simultaneously with display of the geographic map.

In another embodiment of the invention there is provided a computerized method of placing AcID tags on a map in a graphical output. The map displays icons representing aircraft in flight. In this embodiment, the method includes retrieving data previously stored for which there is real time flight information, such data pertinent to flight data to be displayed on the map, processing the retrieved data to identify icon locations for placement of aircraft icons on the map corresponding to positions of the aircraft, further processing the retrieved data to identify tag locations for placement of AcID tags on the map, wherein each tag location for an aircraft is defined by using the aircraft's target airport as a reference, and providing a graphical output using the icon locations and the tag locations.

In a related embodiment the further processing includes assigning each such tag location to a primary position when available that is proximate to the corresponding icon and also generally aligned with a radial line running from the target airport through the corresponding icon.

In a further related embodiment the primary position is radially outside of the position of the corresponding icon with respect to the target airport.

In another further related embodiment when the primary position is not available for a selected tag, further processing includes assigning the selected tag location to a secondary position that is incrementally angularly displaced about the corresponding icon location from the primary position.

In another embodiment of the invention a computerized method of representing flight delay status on a map in a graphical output is provided. The map displays icons representing aircraft in flight. The method includes retrieving data previously stored for which there is real time flight information, such data pertinent to flight data to be displayed on the map, processing the retrieved data to identify icon locations for placement at least of aircraft icons on the map corresponding to positions of the aircraft, further processing the retrieved data to associate with each aircraft a visual characteristic, of at least one of its icon and its AcID tag, that is indicative of delay status of the flight, and providing a graphical output using the icon locations and the visual characteristic. The icon characteristic may be color. A first color of any icon may indicate that the flight to which the icon corresponds is delayed and a second color of the icon may indicate that the flight to which the icon corresponds is on time.

In a related embodiment of the invention visual appearance of the icon is modified according to the extent by which the flight to which the icon corresponds is delayed.

### BRIEF DESCRIPTION OF THE DRAWINGS

The foregoing features of the invention will be more readily understood by reference to the following detailed description, taken with reference to the accompanying drawings, in which:

FIG. 1 is a representation of a display of real-time flight tracking data, here for the Louisville International Airport, in accordance with an embodiment of the present invention;

FIG. 2 is a representation of display, in accordance with the same embodiment as in FIG. 1, captured a few minutes after the representation of FIG. 1, showing dynamic changes in content being displayed;

FIG. 3 is a representation of display, in accordance with the same embodiment as in FIG. 1, captured a minutes after the representation of FIG. 2, showing further dynamic changes in content being displayed;

FIG. 4 is a diagram showing communication paths, associated with operation of the display, in accordance with the embodiment of FIG. 1, between a user computer providing the display and a server;

FIG. 5 is a diagram showing the architecture of logical process modules, in accordance with the embodiment of FIG. 1, used to handle data obtained from the server of FIG. 4;

FIG. 6 is a diagram showing logical flow associated with the application framework module of FIG. 5;

FIG. 7 shows View 1 of Example 2, which is a zoomed in map view of Air Tran in-air flights arriving at Boston Logan International Airport (BOS)—Terminal C, with list of all Air Tran flights scheduled to arrive within a relevant timeframe;

FIG. 8 shows View 3 of Example 2, which is a zoomed in map view of Continental in-air flights arriving at Boston Logan International Airport (BOS)—Terminal C, with list of all Continental flights scheduled to arrive within the timeframe;

FIG. 9 shows View 6 of Example 2, which is a zoomed out map view of JetBlue in-air flights arriving Boston Logan International Airport (BOS)—Terminal C, with list of all JetBlue flights scheduled to arrive within the timeframe;

FIG. 10 shows the map region of View 1 of Example 5, where the map is a zoom to ATL at 500 miles, the width calculated to display all arrivals between 16:30 and 17:00 hours; and

FIG. 11 shows the map region of View 2 of Example 5, where the map is a zoom to ATL at 800 miles, the width calculated to display all arrivals between 17:01 and 17:30 hours.

FIG. 12 shows a prior art air traffic display of flights arriving and departing from Las Vegas in which the AcID tags do not overlap one another.

FIG. 13 shows an air traffic display of flights arriving and departing from New Orleans in which the AcID tags have been placed in accordance with an embodiment of the present invention using the target airport as a reference for the placement of the AcID tags.

FIGS. 14 and 15 are logical flow diagrams illustrating tag placement in accordance with embodiments of the present invention.

FIG. 16 represents a display according to another embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

A “client computing device” includes a personal computer having at least one display, a mobile telephone or other portable digital device having an addressable display and capable of running local applications, such as Flash, or JavaScript or Java applets, in connection with a browser.

A “pre-specified category” of flights means a group of flights associated with a flight attribute or a geographic area in which such flights are present. The association with an attribute can be based explicitly on presence of the attribute in the flight (such as a flight employing a specific aircraft) or a temporal one (such as a flight that currently satisfies criterion x or that satisfied criterion x in the previous two hours). Some examples of a pre-specified category of flights are:
All flights arriving and departing from a particular airport, say, Boston Logan Airport (BOS);
All flights whose aircraft are of a certain aircraft manufacturer, say all Gulfstream aircraft;
All flights arriving into any of the three major New York area airports, JFK, LaGuardia (LGA) and Newark, N.J. (EWR);
All flights arriving into any of the three major New York area airports, JFK, LaGuardia (LGA) and Newark, N.J. (EWR) or that have previously arrived and landed within the past two hours; and
All flights currently over Texas.

“Flight attribute” means a characteristic of the flight. Some examples of a flight attribute are: departure airport, arrival airport, scheduled departure time, scheduled arrival time, actual departure time, actual arrival time, estimated arrival time, aircraft type, airline that is operating the flight, airline that is code-sharing the flight, flight number, aircraft type, altitude of the flight, aircraft tail number, past, present or future flight plan waypoint for the flight, and past, present or future latitude and longitude of the flight.

To “coordinate” contents of a list of flights with a view means to list selected flights of the pre-defined category that are meaningful to the flights displayed on the map view.

Some examples of coordinating the list of flights with the view are as follows.
A simple example is when the pre-specified category is all flights arriving at a particular airport and each view zooms to different map widths around the airport, displaying the flights as a series by zoom level. In this simple example, the list shows just the flights that are currently displayed on the map.
A second example has views similar to the previous examples, but the list continuously scrolls through all flights arriving at that airport, including scheduled but not yet in-air, in-air, and landed flights. (See Example 1 in paragraphs [0054] and [0055] below.)
A third example has a pre-specified category of all flights in a region, say departing from or arriving at JFK, EWR, and LGA. The map would cycle through showing all the arrivals to and departures from JFK, while the list shows all the arrivals to JFK. Next the view shows all the arrivals to and departures from EWR. The list changes to show all the arrivals to EWR, etc. (See Example 4 in paragraph [0064] and [0065] below.)
A fourth example is to show all the flights arriving at an airport on the map view while the list shows only the flights for one airline at a time, cycling through each airline.

A “plurality of geographic regions” shown in a map includes a series of views of different locations, such as airports or terminals, as well as a series of views associated with a single location, such as an airport, wherein the views are the result of panning or zooming or both panning and zooming.

An “AcID tag” is a tag providing, for a specific aircraft flight represented by an icon on a map, flight attribute information for the flight, such as flight number, airline, aircraft type, etc. The flight attribute information may be expressed by means including text information, color code, logo, etc.

“Real time” flight information means flight information pertaining to any of flights in progress, flights recently in progress, and flights expected to be in progress, within the rhythm of operations of auxiliary support services at an airport, such as baggage handling, boarding supervision, airplane ramp operations, passenger greeting services, and limousine services. Flight information that has been delayed a number of minutes (for reasons including security) is still “real time” flight information for purposes of this definition.

“Target airport”. An airport with respect to which in a display view an aircraft is shown heading toward, or departing from, is the “target airport” for such aircraft,

A “graphical output” is a digital output for driving a display or printer associated with a computer.

A position for an AcID tag is “available” if, according to pre-established criteria, use of the position for placement of the tag does not obscure or overlap a specified feature such as other aircraft icons or AcID tags (or potentially other displayed information) to a degree deemed unacceptable.

Embodiments of the present invention systematically and automatically display potentially large amounts of flight data in such a manner that the user may easily find flight information of interest. Embodiments of the present invention rely on coordinated and simultaneous display of several different kinds of information in distinct formats.

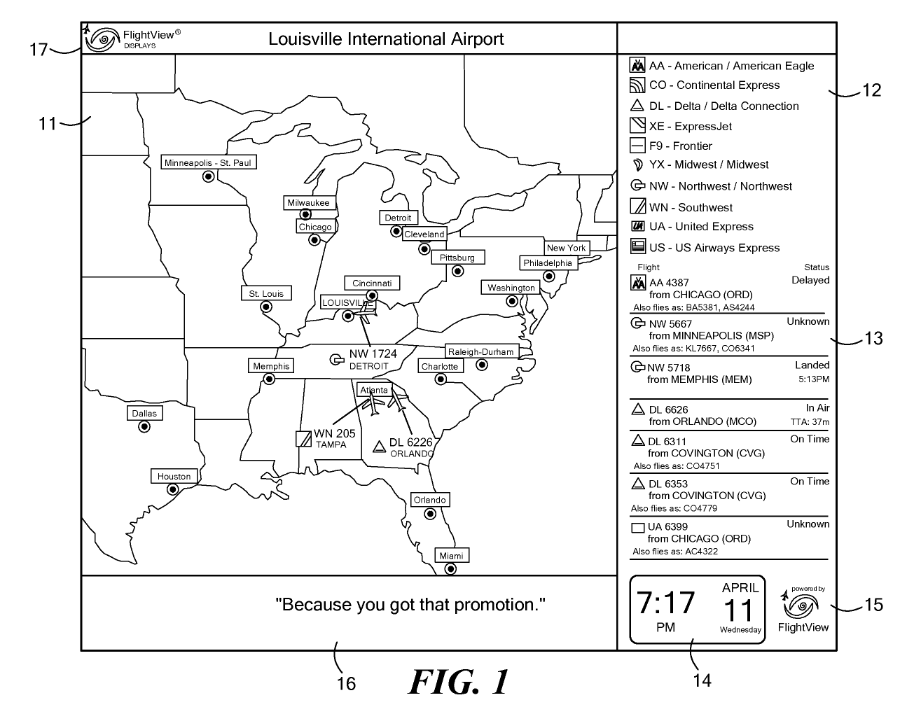

FIG. 1 is a representation of a display of real-time flight tracking data, here for the Louisville International Airport, in accordance with an embodiment of the present invention. The display includes a map region 11 on which are superposed, according to location (based on live data) icons for aircraft in flight, along with airline abbreviation, logo, and flight number comprising an AcID tag. In lower right of the display is a scrolling list 13 of in-progress and recently landed flights for the relevant area, in this case the Louisville International Airport, each flight being identified by airline abbreviation and logo, and also showing other flight information such as departure airport, or whether the flight is on time, delayed, landed, and in air and code-sharing information for the flight. In this figure, the list 13 scrolls in an upward direction, and an American Airlines flight from Chicago has become partially obscured as a result of the scrolling; the scrolling list 13 also shows flights by Northwest Airlines, Delta Airlines, and United Airlines. The scrolled list is updated in real time. To permit decoding of the scrolling list 13 and abbreviations on the map, the display also includes, in the upper right, a region 12 in which is provided a table correlating airline abbreviations and logos with the corresponding airline.

The display of FIG. 1 includes a frame 17 that does not change with time. In FIG. 1, the frame 17 includes the heading “Louisville International Airport” and (also at the top of the display, on the upper left) the product trademark, here “FlightView® DISPLAYS” with design. The display of FIG. 1 also includes a further trademark indicator 15, which is a logo placed in the right-hand corner. A date/time panel 14 in the lower right-hand corner provides current date and time information. Advertisements or announcements are placed in region 16.

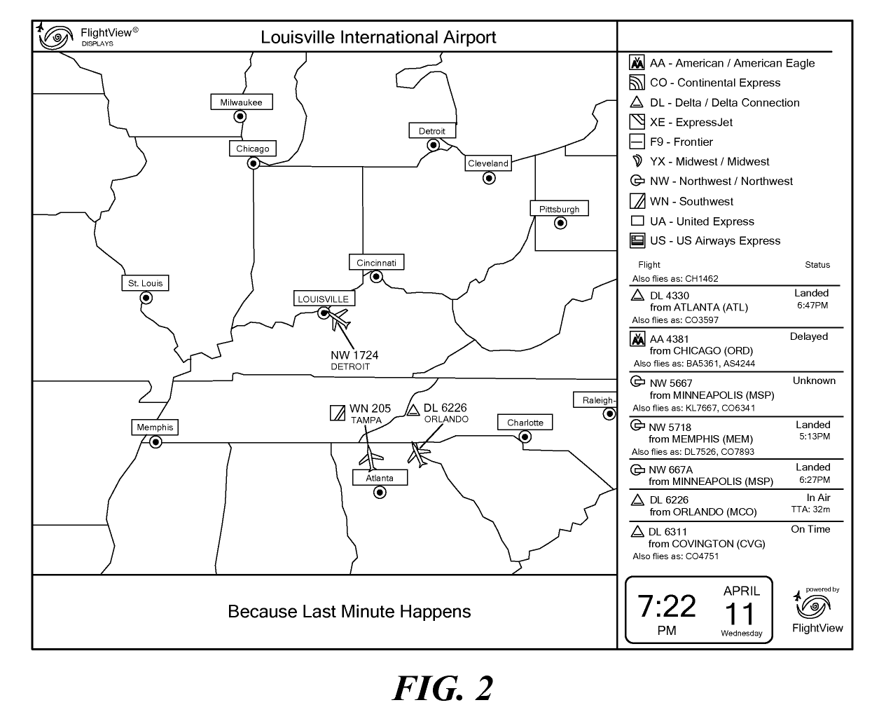

FIG. 2 is a representation of display, in accordance with the same embodiment as in FIG. 1, captured a few minutes after the representation of FIG. 1, showing dynamic changes in content being displayed. In particular, the map region 11 undergoes zooming in and zooming out on a repetitive basis, and here the map region encompasses a smaller geographic area than the map region of FIG. 1. Here also it can be seen that the scrolling list 13 of FIG. 1 has moved to a new position. The American Airlines flight of FIG. 1 here occupies the second position on the list, and a Delta Airlines flight is above it.

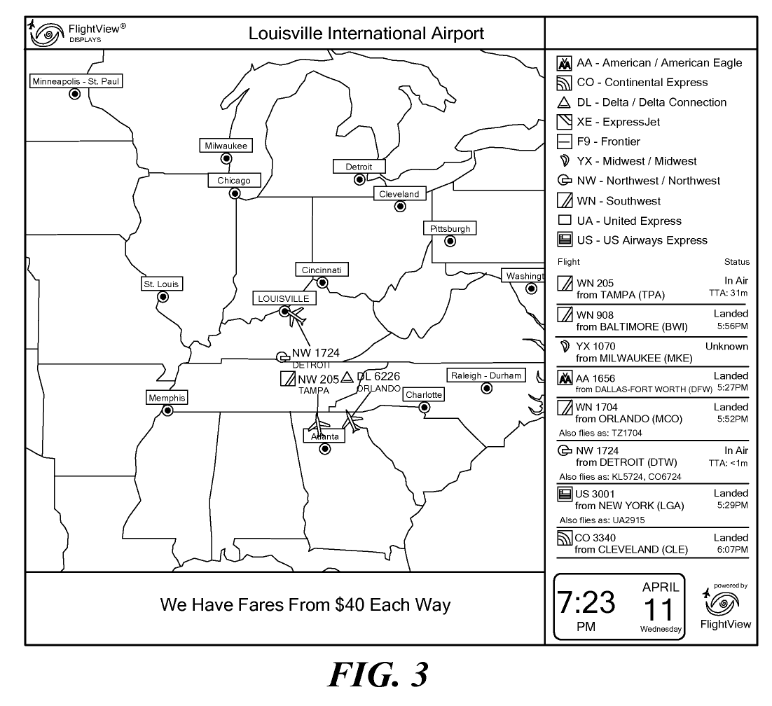

FIG. 3 is a representation of display, in accordance with the same embodiment as in FIG. 1, captured a minute after the representation of FIG. 2, showing further dynamic changes in content being displayed. As a result of repetitive zooming, the map region 11 here encompasses a geographic area that is intermediate in size relative to the geographic areas of the map region of FIGS. 1 and 2. Similarly, the scrolling list 13 now shows Southwest Airlines flights at the top, then a flight of Midwest Airlines, followed by a different American Airlines flight.

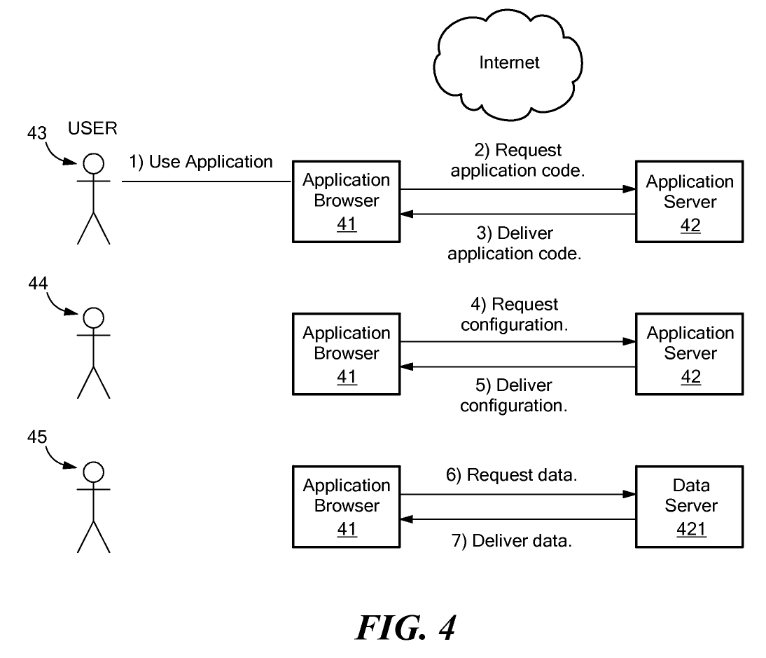

FIG. 4 is a diagram showing communication paths, associated with operation of the display, in accordance with the embodiment of FIG. 1, between a user computer providing the display and a server. In process 43, the application browser 41, running on a user's computer, is invoked, for example by the user, and the browser is directed to the URL of an application server 42. Depending on the configuration, browser 41 may initiate a request to download code, or the server 42 causes the browser to download code, which we have implemented in Flash, which, when downloaded, begins running in the browser application that in turn is running in the user computer. (Alternatively, other code may be used, such as JavaScript or Java, for example.) In process 44, the code running in the user's browser 41 requests configuration data, which are downloaded from server 42 to the user's computer for use in the browser application 41. In process 45, the browser 41 makes a request for data, and optionally the request is made to a distinct data server 421; otherwise the request may be made to the server 42. The data are supplied and downloaded for use by code running in the browser.

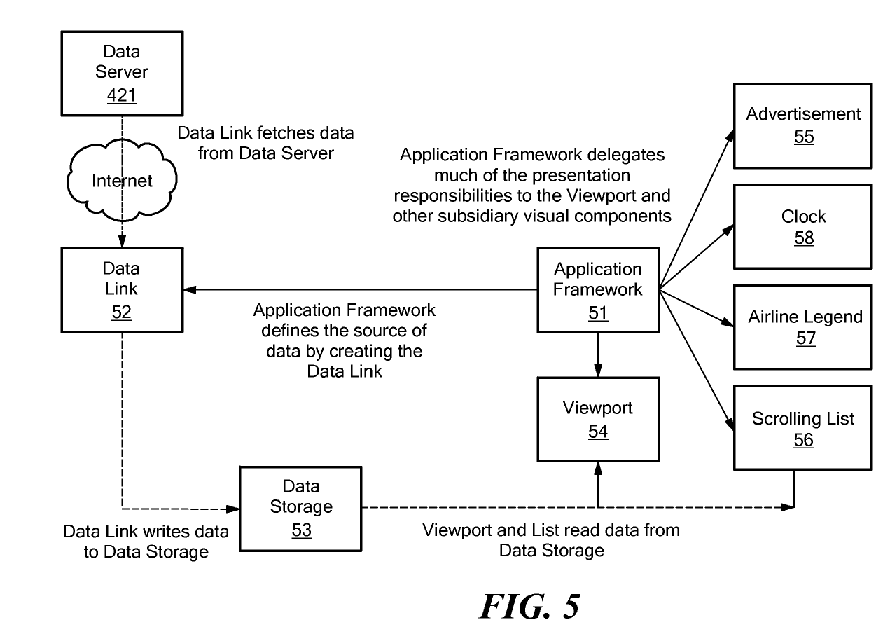

FIG. 5 is a diagram showing the architecture of logical process modules, in accordance with the embodiment of FIG. 1, used to handle data obtained from the server of FIG. 4. The application framework 51 is a key module of the architecture. The application framework 51 establishes data link process 52, which communicates with data server 421 of FIG. 4. (Except for data server 421, all of the modules depicted here are running on the user computer as processes within the browser application.) The data link process 52 causes storage, in data storage 53, of data obtained from the data server 421. The application framework 51 establishes the viewing elements that are displayed by the browser and discussed above in connection with FIGS. 1-3. The application framework 51 populates the design elements such as the frame 17 and the logo 15 of FIG. 1. The application framework 51 establishes the viewport module 54, which in turn accesses data from data storage 53 to place into the map region shown in region 11 of FIG. 1. The application framework 51 uses airline legend module 57 to populate the table, in region 12 of FIG. 1, correlating airline abbreviations and logos with the corresponding airline. The application framework 51 uses list module 56 to access data from data storage 53 to populate the scrolling list 13 (shown in FIG. 1) of in-progress and recently landed flights for the relevant area. The application framework 51 uses advertisement module 55 to populate the display with advertisements or announcements in region 16 of FIG. 1 and uses clock module 58 to populate the date/time panel 14 of FIG. 1. The data link 52 signals when new data is available in data storage 53. This new data is received by viewport 54 and list 56 and, if needed, causes a refresh to the map region and the scrolling list.

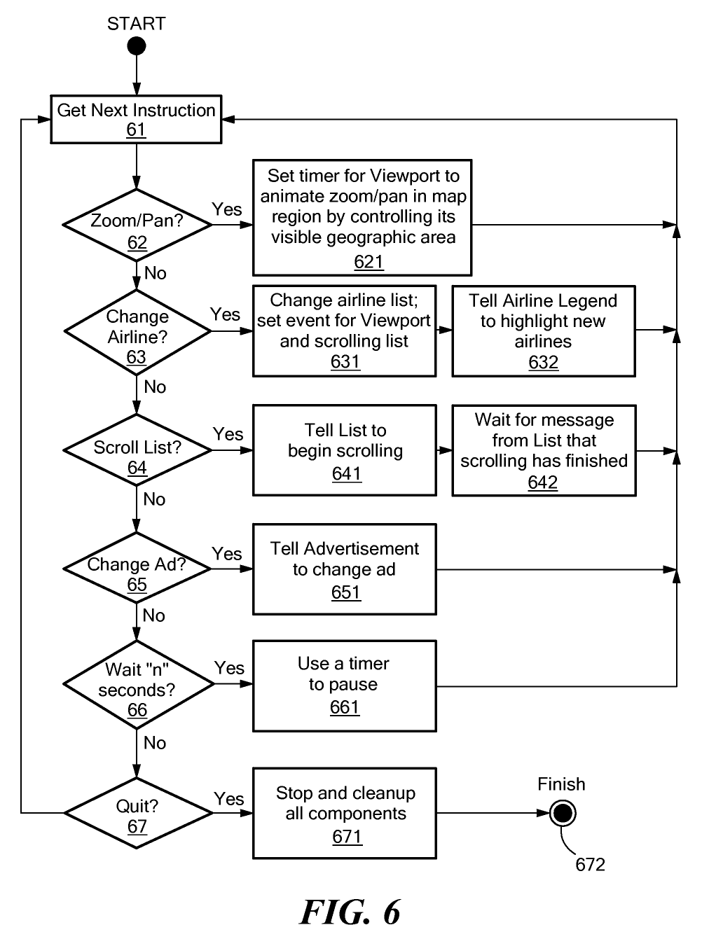

FIG. 6 is a diagram showing logical flow associated with the application framework module 51 of FIG. 5. The application framework module in process 61 gets the next instruction and cycles through a series of tests for whether the instruction is pertinent to any of a variety of modules of FIG. 5, and if the test indicates the need for activity of the module, then the application framework module triggers the module to handle the relevant instruction. Thus there is a test for zoom/pan in process 62, and if the answer is in the affirmative, then in process 621, a timer in the viewport module 54 of FIG. 5 is used to animate the zoom/pan function in the map region by controlling its visible geographic area. There is a test in process 63 for whether the pending instruction is to change the airline displayed, and if the answer is in the affirmative, then in process 631, the airline list is updated to reflect the updated airline (or airlines) to be displayed and an event is set for viewport 54 and list 56 modules of FIG. 5. This event causes the viewport module 54 and the list module 56 to use the updated airline list to modify the map region 11 and the scrolling list 13 respectively of FIG. 1. Additionally in process 632, the airline legend module 57 is signaled to use the updated airline list to modify the airline legend element 12 of FIG. 1. There is a test for scroll list in process 64, and if the answer is affirmative, then in process 641, the process in the list module 56 handling the scrolling of in-progress and recently landed flights is caused to begin scrolling, and, in process 642, control waits for a message from the same process in the list module 56 that scrolling has finished. There is a test for change advertisement in process 65, and if the answer is affirmative, then in process 651, the advertisement process in the advertisement module 55 is instructed to modify the advertisement. There is a test in process 66 for whether a pause instruction was placed, and if the answer is affirmative, then in process 661, then a timer is used to establish a pause. Finally in process 67, there is a test for a “quit” instruction, and if the answer affirmative, then in process 671, execution stops, and relevant component processes are cleaned up, and execution is finished in process 672.

### EXAMPLES

The embodiments illustrated herein permit coordination of elements displayed, so that, for example, display of a map view can be coordinated with display of the scrolling list. We provide some examples herein.

In Example 1 the map views show in-air flights arriving Huntsville airport (HSV) while the scrolling list displays all flights scheduled to land at HSV within a timeframe. The listed flights includes all in-air flights, all flights not yet in-air but scheduled to arrive within a timeframe, and flights recently landed. Each map view shows the in-air flights visible at various zoom levels.

### Example 1

### Huntsville Airport (HSV), Alabama—Arrivals Display

| | Display | | | |
|---|---|---|---|---|
| | Map View | | | |
| | | Zoom to/Width | List Configuration | |
| View | Flights Displayed On Map | (miles) | Flights Scrolled on List | Sort by: |
| View 1 | All in-air flights | Airport/500 | All flights scheduled to | Flight # |
| | arriving at HSV | | land at HSV within | (For example, |
| | | | timeframe, including | AA100, |
| | | | scheduled, in-air and | DL21, |
| | | | landed. | UA 12) |
| View 2 | All in-air flights | Southeast US | All flights scheduled to | Flight # |
| | arriving at HSV | View/1500 | land at HSV within | |
| | | | timeframe | |

In this example and the following examples, in defining a pre-specified category of flights (besides those flights currently airborne), those flights that have landed or that are scheduled to depart can each be associated with a timeframe selected according to convenience and interest. For example, for flights that have landed, the timeframe may include all of those landing within 2 hours of the current time. For flights scheduled to depart, the timeframe may include all of those scheduled to depart anytime between the current time and up to 6 hours in the future. The list may give relevant information about each flight, such as departure airport, expected time of arrival or exact arrival time, and the status, for example “landed”, “in air”, or “scheduled”.

Also, in this and the following examples the numbers given for zoom width are given for illustrative purposes. The zoom widths can be set values or calculated by using the location of the flights to determine the width needed to display all the flights in the set.

### Example 2

### Boston Logan International Airport (BOS)—Arrivals Display by Terminal and Airline

| | Display | | | |
|---|---|---|---|---|
| | Map View | | | |
| | | Zoom to/Width | List | |
| View | Flights Displayed On Map | (miles) | Flights Scrolled on List | Sort by: |
| View 1 | AirTran Airways | Airport/500 | Air Tran (FL) flights scheduled | Flight # |
| | (FL) flights arriving | | to land at BOS Terminal C | |
| | at BOS Terminal C | | within timeframe. | |
| View 2 | AirTran Airways | Center | AirTran Airways (FL) flights | Flight # |
| | (FL) flights arriving | Northeast US/ | scheduled to land at BOS | |
| | at BOS Terminal C | 1000 | Terminal C within timeframe | |
| View 3 | Continental Airlines | 500 miles | Continental (CO) flights | Flight # |
| | (CO) flights arriving | | scheduled to land at BOS | |
| | at BOS Terminal C | | Terminal C within timeframe | |
| View 4 | Continental Airlines | Center | CO flights scheduled to land at | Flight # |
| | (CO) flights arriving | Northeast US/ | BOS Terminal C within | |
| | at BOS Terminal C | 1000 | timeframe | |
| View 5 | JetBlue Airways (B6) | 500 miles | JetBlue (B6) flights scheduled to | Flight # |
| | flights arriving at | | land at BOS Terminal C within | |
| | BOS Terminal C | | timeframe | |
| View 6 | JetBlue Airways (B6) | Center | B6 flights scheduled to land at | Flight # |
| | flights arriving at | Northeast US/ | BOS Terminal C within | |
| | BOS Terminal C | 1000 | timeframe | |

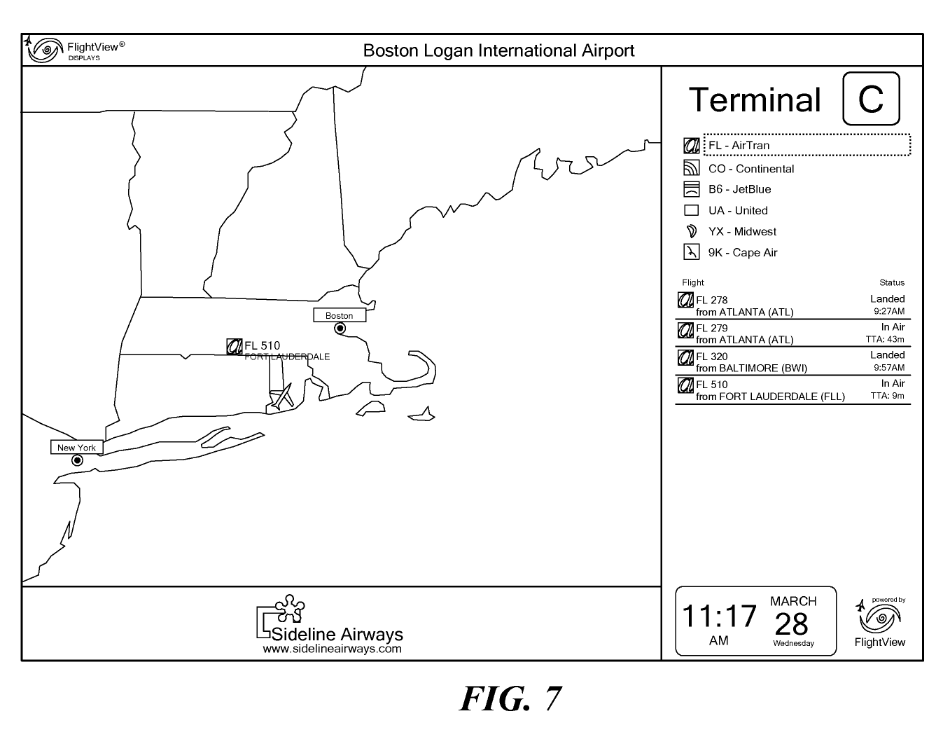

We show three figures to illustrate the effect of Example 2. In FIG. 7 we show View 1 of Example 2, which is a zoomed in map view of Air Tran in-air flights arriving at Boston Logan International Airport (BOS)—Terminal C, with list of all Air Tran flights scheduled to arrive within a relevant timeframe. Thus, the list shows four Air Tran flights, two that have recently landed and two that are in air. One in-air flight, FL510, is visible on the zoomed in map and the second in-air flight, FL279, is not yet visible on the zoomed in map.

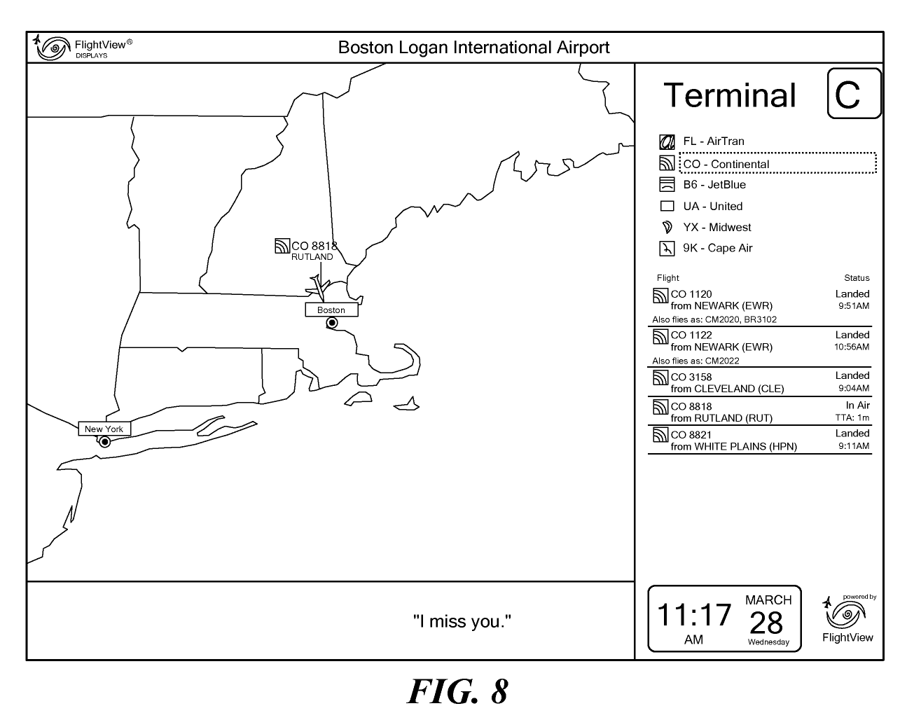

In FIG. 8, we show View 3 of Example 2, which is a zoomed in map view of Continental in-air flights arriving at Boston Logan International Airport (BOS)—Terminal C, with list of all Continental flights scheduled to arrive within the timeframe.

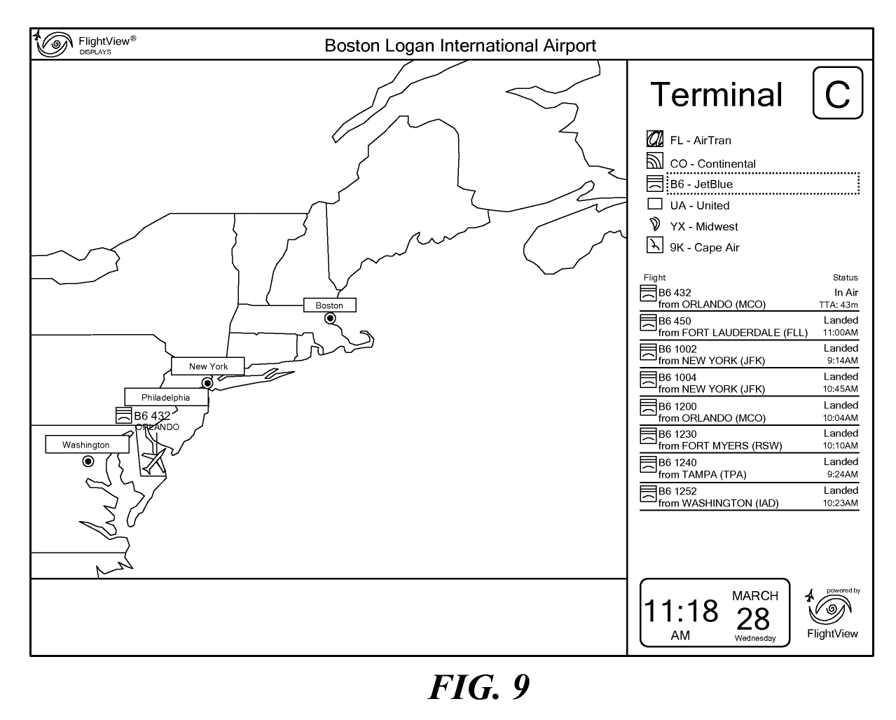

FIG. 9, we show View 6 of Example 2, which is a zoomed out map view of JetBlue in-air flights arriving Boston Logan International Airport (BOS)—Terminal C, with list of all JetBlue flights scheduled to arrive within the timeframe.

Example 3 illustrates the display of all the flights for a particular region, in this case, flights arriving New York airports JFK and LaGuardia (LGA) and New Jersey airport Newark (EWR). The display starts with the first airport, showing flights arriving at JFK. To keep the example simple, we show just two airlines for each airport. The map view shows American in-air flights arriving JFK and lists all American flights, scheduled, in-air, and landed, arriving JFK. After a pause, for example, 10 seconds, the view is changed to show all United in-air flights and the list is also changed to show all United flights, scheduled, in-air, and landed, arriving into JFK. After a pause the view shows all American in-air flights arriving LGA, while the list changes to show all American flights, scheduled, in-air, and landed, arriving LGA. This continues until the flights for each airline at each airport has been displayed. It then repeats the cycle, starting again with JFK.

### Example 3

### New York City Convention Center Covering New York Airports—JFK and LGA (LaGuardia), and New Jersey Airport EWR (Newark, N.J.) Arrivals

| | Display | | | |
|---|---|---|---|---|
| | Map View | | | |
| | | Zoom to/Width | List | |
| View | Flights Displayed On Map | (miles) | Flights Scrolled on List | Sort by: |
| View 1 | American Airline (AA) | 500 miles | AA flights arriving JFK within | Flight # |
| | in-air flights arriving at | | timeframe | |
| | JFK | | | |
| View 2 | United Airline in-air | 500 miles | UA flights arriving JFK within | Flight # |
| | flights arriving at JFK | | timeframe | |
| View 3 | American Airline (AA) | 500 miles | AA flights arriving LGA within | Flight # |
| | in-air flights arriving at | | timeframe | |
| | LGA | | | |
| View 4 | United Airline in-air | 500 miles | UA flights arriving LGA within | Flight # |
| | flights arriving at LGA | | timeframe | |
| View 5 | American Airline (AA) | 500 miles | AA flights arriving EWR that within | Flight # |
| | in-air flights arriving at | | timeframe | |
| | EWR | | | |
| View 6 | United Airline in-air | 500 miles | UA flights arriving EWR that within | Flight # |
| | flights arriving at EWR | | timeframe | |

In Example 4, similar to Example 3, all the flights for JFK, LGA, and EWR are shown airport by airport. However, in Example 4, the map view shows all the in-air flights departed or arriving at each airport and the list only shows the arriving flights for that airport.

### Example 4

### New York City Convention Center Covering New York Airports—JFK and LGA (LaGuardia), and New Jersey Airport EWR (Newark, N.J.) Arrivals and Departures

| | Display | | | |
|---|---|---|---|---|
| | Map View | | | |
| | | Zoom to/Width | List | |
| View | Flights Displayed On Map | (miles) | Flights Scrolled on List | Sort by: |
| View 1 | All flights departed or | 1000 miles | All flights arriving JFK within timeframe, | Flight # |
| | arriving JFK | | including scheduled, in-air, and landed | |
| View 2 | All flights departed or | 1000 miles | All flights arriving LGA within | Flight # |
| | arriving LGA | | timeframe, including scheduled, in-air, | |
| | | | and departed | |
| View 3 | All flights departed or | 1000 miles | All flights arriving EWR within | Flight # |
| | arriving EWR | | timeframe, including scheduled, in-air, | |
| | | | and landed | |

In another example we provide a display for Atlanta airport.

### Example 5

### Atlanta Hartsfield International Airport (ATL), Georgia—Arrival Display by Arrival Time

| | Display | | | |
|---|---|---|---|---|
| | Map View | | | |
| | | Zoom to/Width | List | |
| View | Flights Displayed On Map | (miles) | Flights Scrolled on List | Sort by: |
| View 1 | Flights arriving ATL | ATL/width | Flights arriving | Flight Arrival |
| | between 16:31 and 17:00 | calculated by | between 16:31 to 17:00 | times, ascending |
| | | position of flights = | | |
| | | 500 | | |
| View 2 | Flights arriving ATL | ATL/width | All flights arriving | Flight Arrival |
| | between 17:01 and 17:30 | calculated by | between 17:01 and | times, ascending |
| | | position of flights = | 17:30 | |
| | | 800 | | |
| View 3 | Flights arriving ATL | ATL/width | All flights arriving | Flight Arrival |
| | between 17:31 and 18:00 | calculated by | between 17:31 and | times, ascending |
| | | position of flights = | 18:00 | |
| | | 900 | | |
| . | | | | |
| . | | | | |
| . | | | | |
| View 6 | Flights arriving ATL | ATL/width | Flights arriving | Flight Arrival |
| | between 20:00 and 21:00 | calculated by | between 20:00 and | times, ascending |
| | | position of flights = | 21:00 | |
| | | 1800 | | |
| View 8 | Flights arriving ATL after | Center US/width | All flights arriving after | Flight Arrival |
| | 21:00 | calculated by | 21:00 & all flights that | times, ascending |
| | | position of flights = | have landed in last 4 | |
| | | 2800 | hours | |

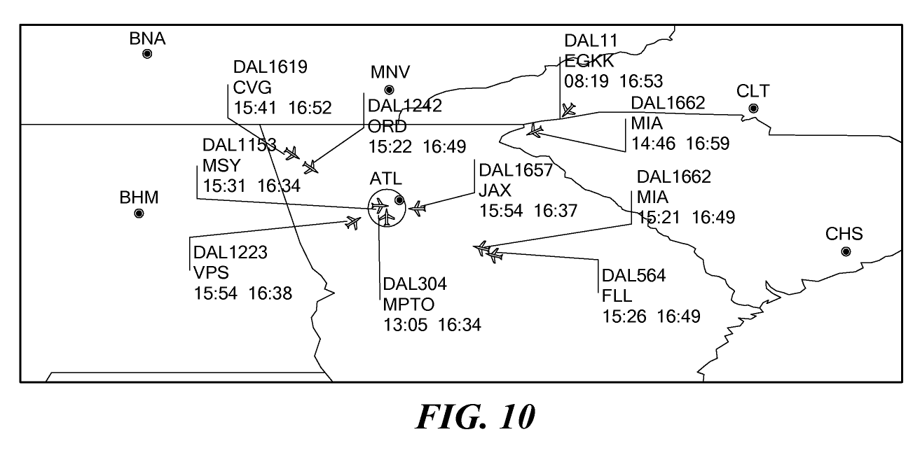

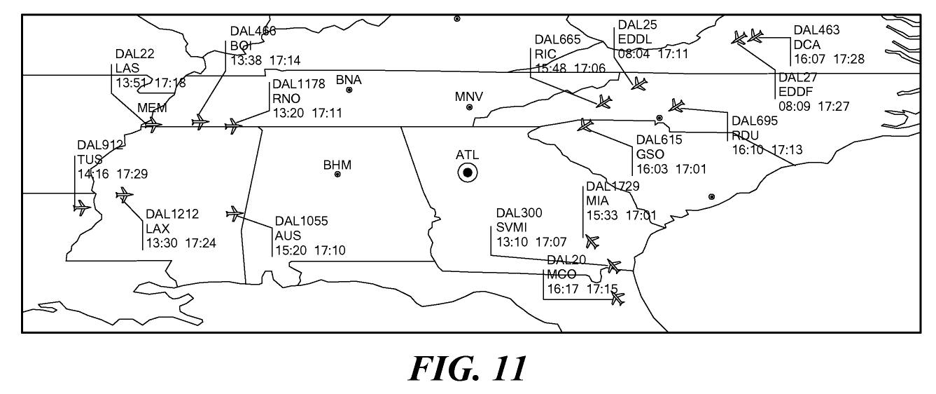

We have two figures to illustrate Example 5. In FIG. 10, we show the map region of View 1 of Example 5, where the map is a zoom to ATL at 500 miles, the width calculated to display all arrivals between 16:30 and 17:00 hours. In FIG. 11, we show the map region of View 2 of Example 5, where the map is a zoom to ATL at 800 miles, the width calculated to display all arrivals between 17:01 and 17:30 hours.

Algorithms

We now turn to algorithms used to handle flight display in various embodiments of the present invention. Various algorithms may be used to establish criteria associated with each view to automatically and repetitively display the flight information. In the following list of flight display algorithms, for simplicity, the algorithms detail arrivals to a specific airport, but they can also be applied to departures or other subcategories of flights. In each of these algorithms, the geographical map is zoomed to accommodate the display of each group of flights.

Zoom Algorithm

This algorithm displays the flights in a series of flights grouped by distance from the airport. The steps that are repeated for this algorithm are:
1. Zoom in to xx miles of the airport where xx a function of the location and/or number of arrivals for the airport. Highlight all aircraft that are within that area.
2. Zoom out to xx+yy miles of the airport where yy is a function of the location and/or number of arrivals at the airport. Minimize previously displayed aircraft. Highlight all aircraft that are in that area not previously displayed.
3. Zoom out again xx+zz where zz may be 2yy or another value dependent on the location and/or number of arrivals at the airport. Minimize all previously displayed aircraft and highlight all new aircraft that were not previously displayed.
4. Repeat step 3 until the total area is reached, for example, North America

Time-to-Land Algorithm

This algorithm is used in Example 5 with sample map views shown in FIGS. 10 and 11. It establishes the criteria for displaying the flight information in series of views with flight information separated into each view by time-to-land, or arrival time. The geographical map is zoomed out to accommodate the display of the flights. The steps that are repeated for this algorithm are:
1. Zoom in to xx miles of the airport where xx a function of the highlighting all flights within mm minutes to land. Highlight all aircraft that are within that area.
2. Zoom out to xx+yy miles of the airport where yy is a function showing all flights within mm+dd minutes to land where dd is a determined by the location and/or number of arrivals at the airport. Minimize all previously displayed aircraft. Highlight all aircraft that are that were not previously displayed.
3. Repeat #2 until final map size is reached, for example North America

Airline Algorithm

This algorithm is shown in FIGS. 7, 8, and 9 where the arrivals into Boston Logan International Airport are displayed in views that cycle through each airline. The steps that are repeated for this algorithm are:
1. Highlight all flights for a single airline for nn minutes
2. Minimize all previously displayed airlines
3. Highlight all flights for the next airline
4. Continue cycling through minimizing previously displayed airlines and highlighting the next airline to be shown until all flights have been shown.

Spacing Algorithm

This algorithm allows for the display of flights in a manner that enables the user to easily observe all the flight data in a potentially flight-congested area The steps for this algorithm are:
1. Zoom to desired area
2. Build a list of all aircraft arriving at the airport to be displayed
3. Highlight first aircraft on the list
4. Test if next aircraft is not within xx miles of a currently highlighted aircraft
   if no, highlight this aircraft.
      Else go to the next aircraft to be displayed.
5. Repeat #4 until all aircraft on list have been tested
6. If not all aircraft were displayed
   wait nn minutes
   minimize currently highlighted aircraft
   repeat 3 and 4 for the remaining flights not previously displayed
7. repeat 6 until all flights have been displayed

Minimizing and Highlighting

In the previous algorithms the terms “minimizing” and “highlighting” refer to techniques to display the aircraft in such a manner where the highlighted aircraft are displayed such that the user can easily see the flight information for the aircraft. The minimized aircraft are not displayed or displayed in such a way that they may display or indicate some information but do not interfere with the display of the highlighted aircraft.

For example, a highlighted aircraft could be displayed in a bold color such as yellow, showing the aircraft icon and an AcID tag that indicates the airline logo, flight number, departure and arrival airport, the departure time and estimated time of arrival, the speed and altitude of the aircraft. A minimized aircraft may be a transparent aircraft icon indicating just its position. Minimizing may also be employed to remove the aircraft and its information from the display.

AcID Tag Placement

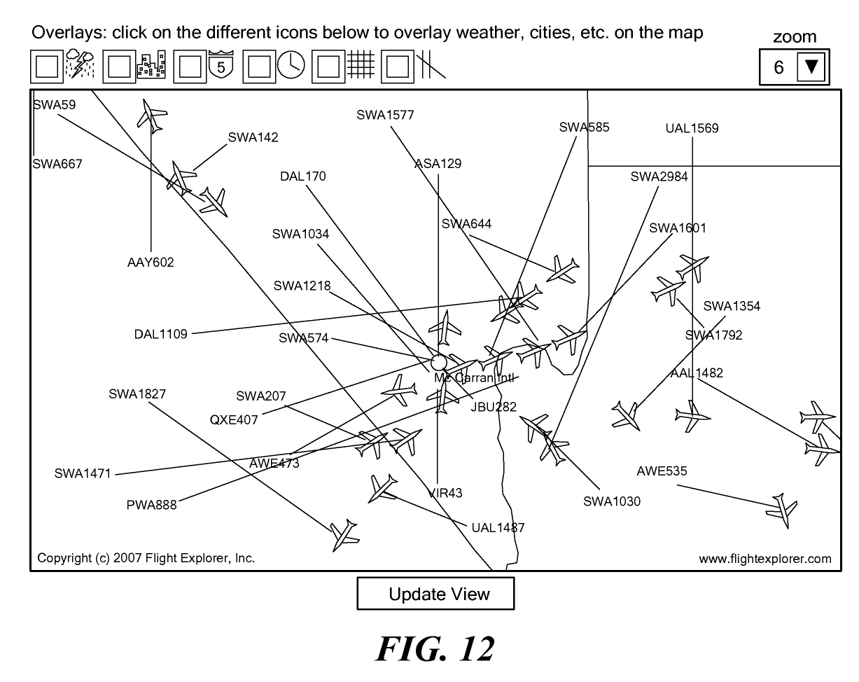

FIG. 12 shows a prior art air traffic display of flights heading toward and Departing from Las Vegas in which the AcID tags does not overlap. The resulting display is chaotic.

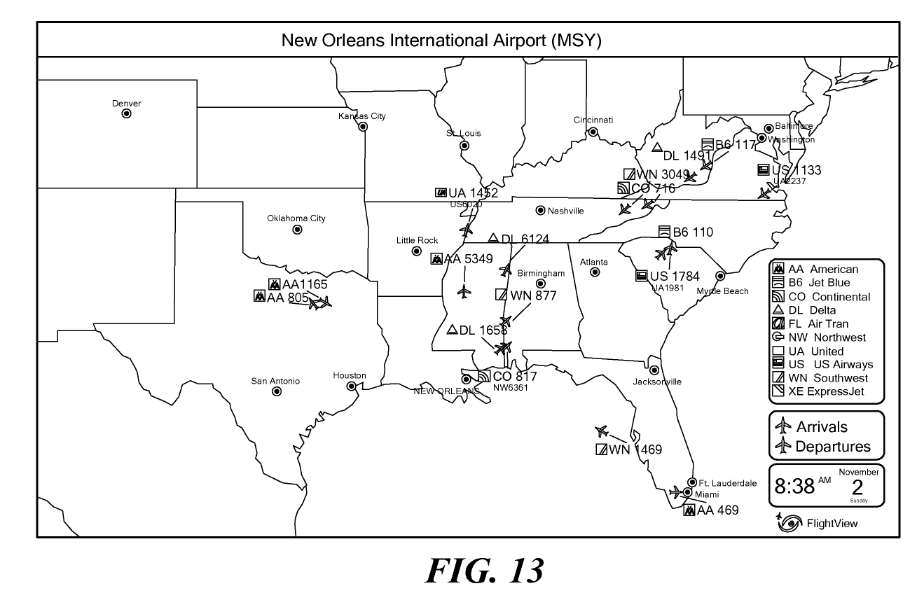

FIG. 13 shows an air traffic display of flights heading toward and departing from New Orleans in which the AcID tags have been placed in accordance with an embodiment of the present invention using the destination/departure airport as reference for the placement of the AcID tags. In this embodiment, the tag placement permits easy visual association by the viewer of each tag with its corresponding aircraft icon.

Where possible the AcID tags are located radially outside of the position of the corresponding icon with respect to the target airport, thereby providing a more readable display.

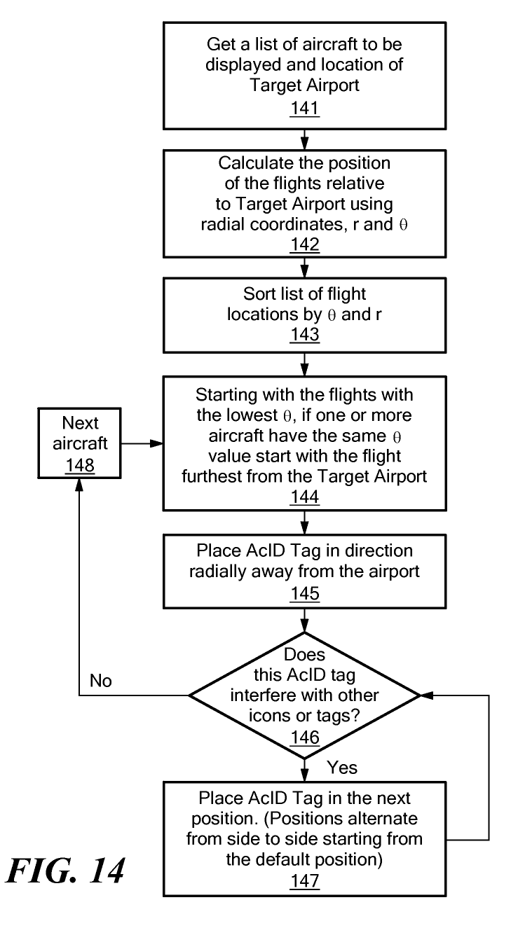

The aircraft display can be more useful when each displayed aircraft is labeled with an associated AcID tag. Preferably AcID tags are placed so that they do not obscure other aircraft icons or ACID tags. In many cases the aircraft shown in a given view are all heading toward, or departing from a single airport; furthermore air traffic to and from airports is controlled by the FAA so that flights follow a specific corridors or flight paths, which change based on the weather and other conditions at the airport. One can take advantage of the effect of these two factors, in the placement of the AcID tags to make the display more readable and to reduce overlap of the tags. In one embodiment of the invention, the location of the target airport is used to control tag placement using the following algorithm shown in FIG. 14 and described below.

FIG. 14 is a logical flow diagram illustrating tag placement in accordance with an embodiment of the present invention. Tag placement in accordance with the embodiment demonstrated in FIG. 14 begins with process 141 wherein a list of all aircraft associated with a target airport is retrieved from stored data based on real-time flight information. The aircraft may be heading toward or departing from the target airport. The location of the target airport represents the center point or origin for sorting and ordering tag placement.

In process 142 the position of each aircraft in the list may be calculated and expressed using polar coordinates, wherein the angular position may be denoted by theta, (Θ), and the radial position may be denoted by “r,” both with respect to the origin, the target airport. The angular position is determined in relation to a configurable base direction from the airport (for example due East) that is selected.

In process 143 the list of aircraft to be displayed is sorted with a primary key being the angular position from the configurable base direction, in ascending order, and with a secondary key being the radial distance from the origin at the target airport in question, in descending order. (These may also be configured with different settings for ascending and descending with ultimately different tag placement.) A loop process is initiated in process 144 to determine tag placement of each aircraft in the list. In some embodiments the loop process will begin by determining the tag placement location of the aircraft with the lowest angular displacement (Θ). In this embodiment when more than one aircraft has the same angular displacement, priority is given to the flight that is the furthest from the target airport. In process 145 the AcID tag, for the flight identified in process 144, is placed onto the display in a position radially outside of the position of the corresponding icon with respect to the target airport—in this way planes leaving the target airport are “pushing” the AcID tag ahead of them, while aircraft approaching the target airport are “pulling” the AcID tag. Placing the tags away from the target airport relieves congestion in the display. Although we have described a position for placement of the tag that is radially outside of the position of the corresponding icon, we still find it convenient to orient the tag in a horizontal position. Thus, we say that the tag is “generally aligned” with a radial line running from the target airport through the corresponding icon, even though the tag is oriented horizontally.

In process 146 the AcID tag placement position is evaluated for conflicts with other elements on the map in order to determine whether the position is available. If the AcID tag does not obscure or overlap other aircraft icons or AcID tags or other elements of the display, then the placement is accepted and the next aircraft (based on radial position and radius) is selected via process 148 and the process loops back to process 144. If there is a conflict with another element of the display (an aircraft icon, AcID tag or other element of the display), then process 147 tests a series of alternative tag placements to find the most acceptable position. For example, if an aircraft icon is 90 degrees from the established base direction, then the default AcID tag placement would also be 90 degrees from the established base direction, but if an overlap is detected, then the configurable AcID tag offset would come into play. In accordance with an embodiment of the present invention, the offset denotes rotation of the AcID tag about the corresponding aircraft icon position by a specified number of degrees. For example, if the configurable AcID tag offset were 10 degrees, then an evaluation would be made as to the availability of a position for the AcID tag 10 degrees away from the default AcID tag location. The initial direction (i.e. ±10 degrees) of rotation may also be specified. If the offset position was unavailable, process 147 would continue evaluating positions at increments corresponding to the configurable AcID tag offset on alternating sides of the default AcID tag location. If all positions generated are unavailable, then the AcID tag placement would repeat, but would try to use a longer callout line. The callout line is the line drawn between the aircraft identifier and the AcID tag.

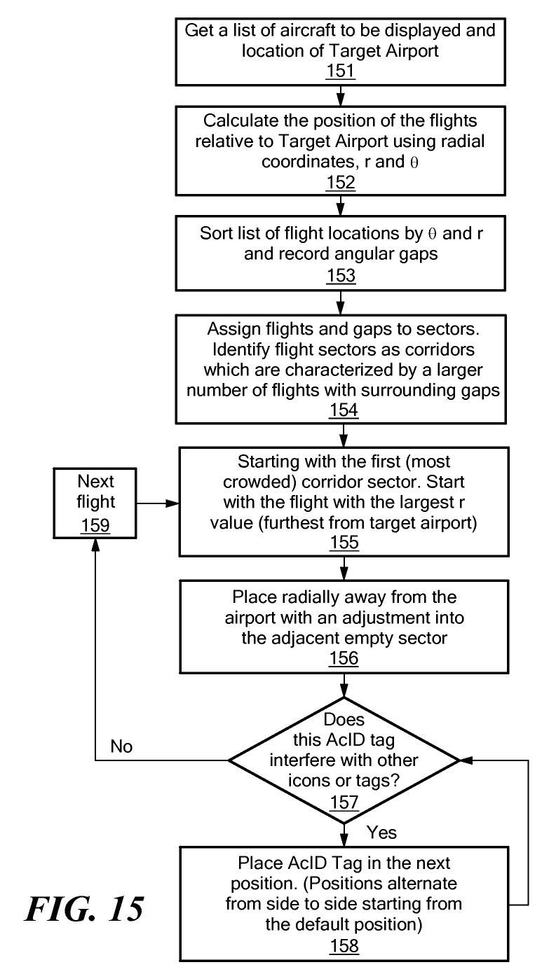

FIG. 15 is a logical flow diagram illustrating tag placement in accordance with another embodiment of the present invention. A list of all aircraft for display is obtained in process 151. In process 152 the positions of the aircraft in polar coordinates relative to the target airport are calculated and then in process 153 the list of flight locations are sorted based on angular position, then on distance from the target airport. Process 153 also includes identifying and recording the angular gaps or corridors in the air traffic pattern (placement of aircraft) around the target airport.

Once the list is sorted, the primary or first tier sort criterion being the angular position, the list may be traversed in process 154, wherein significant angular gaps are identified. If the angular gap between flights adjacent to one another in the sorted list is less than a minimum value, then the set of aircraft are grouped together to represent a corridor of air traffic. The result of process 154 is division of the area around the target airport into a series of angular segments identified as either gaps (no aircraft) or corridors (aircraft present).

AcID tags are applied in processes 155 and 156 using the gaps and corridors to help arrange the AcID tags. In this embodiment the display is constructed by starting with the most crowded corridor and working from the furthest aircraft to the closest aircraft. Once these AcID tags are placed, evaluations are made as to the availability of tag positions for AcID tags in the next most crowded corridor, until all of the AcID tags have been placed. The AcID tag for a given aircraft is provisionally placed in process 156 in a position radially outside of the position of the corresponding icon with respect to the target airport, the position having an offset toward the side of the corridor with the biggest gap. AcID tags may be placed in a regular progression at a configurable default direction, or angular sector based default AcID tag direction, where the AcID tags appear in a row similar to the placement of the aircraft icons. When empty angular sectors appear on both sides of an angular sector heavy with aircraft, then both empty angular sectors may be used for AcID tag placement in an alternating fashion. This allows the display to use the gap space efficiently.

In process 157, the AcID tag placement is evaluated for conflicts with other elements on the map. If the AcID tag does not obscure or overlap other aircraft icons, AcID tags or other elements of the display to an extent deemed unacceptable, then the placement is accepted and the next aircraft (based on radial position within the corridor) is selected via process 159 and the process loops back to process 155. If there is a conflict with another element of the display (an aircraft icon, AcID tag or other element of the display), then process 158 tests a series of alternative tag placements to find the most acceptable position.

Factoring in Distance from the Target Airport

For displays of this nature, the center of activity is the target airport in question where all traffic is arriving or departing. This means that even in a moderately congested airport, there can be many aircraft in close proximity to the airport at the same time. Accordingly, a minimum distance from the airport can be set within which aircraft may be treated differently for display. By way of example, the aircraft may be removed for consideration from where gaps in the angular distance from the established base direction must account for the size of the aircraft icon that will displayed for each aircraft in flight on the display. Alternatively, the aircraft may be removed from consideration when establishing angular sectors, they may appear as a smaller or different aircraft icon, they may be displayed without an AcID tag, or they may be displayed with an AcID tag only when the view is sufficiently zoomed in.

Also, a maximum distance from the airport can be set such that aircraft outside that distance may be treated differently for display. These aircraft may be removed from consideration when establishing angular sectors or they may be displayed without an AcID tag.

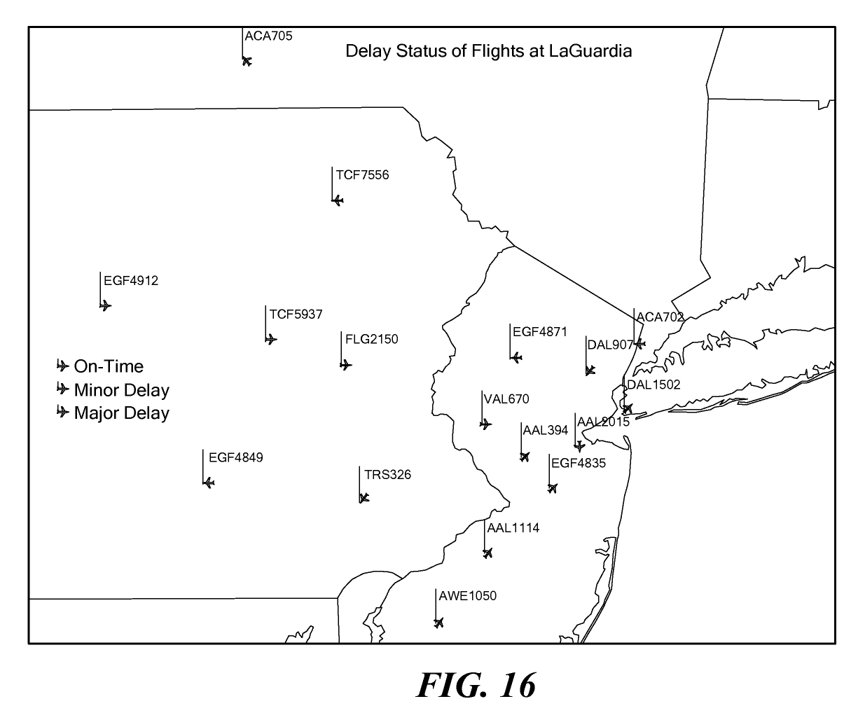

FIG. 16 represents a display according to another embodiment of the present invention. This embodiment provides a computerized method of representing flight delay status on a map in a graphical output. In the map represented in FIG. 16, icons are displayed representing aircraft in flight in such a way as to inform viewers of the map of the delay status of the flights represented by the icons. To provide this display, the system operates by retrieving data previously stored for which there is real time flight information, wherein such data pertain to flight data to be displayed on the map. The retrieved data are processed to identify icon locations for placement of aircraft icons on the map corresponding to positions of the aircraft. Additionally, the retrieved data are processed to associate with each aircraft an icon and or AcID tag visual characteristic that is indicative of delay status of the flight. In FIG. 16, we use color. A green color indicates on-time status; yellow, a minor delay; and red, a major delay. The system may use pre-established criteria to assign each of these categories. For example, a 0-15 minute delay may be considered on time, a 16-45 minute delay be considered a minor delay, and a greater than 45-minute delay may be considered a major delay. However, it is within the scope of the present invention to assign other intervals for these categories and in fact to use more or less granular categories.

Although we have here discussed use of color to indicate delay status, other visual indication may also be utilized, for example, different shading for different delay categories or even different icon types for different delay categories. For example, an icon shaped like an aircraft and bearing a smile may indicate on time, and an aircraft icon bearing a frown may indicate minor delay, and an aircraft icon bearing a tearful scowl may indicate major delay. In FIG. 16, we have used color on both the icon and its associated AcID tag, but color may be used as well on either the icon or the tag.

Combination of Algorithms

These algorithms may be combined to improve information display or to suit a user's needs. For example, a variation of the spacing algorithm may be to run through a list of flights for each airline

As has been stated, embodiments of the present invention systematically and automatically display potentially large amounts of flight data in such a manner that the user may easily find flight information of interest. Embodiments of the present invention rely on coordinated and simultaneous display of several different kinds of information in distinct formats. A further embodiment of the invention allows a user to interact with the system in order to freeze the display to view flight information of interest or to drill down for further information. For example, a user with a mobile phone that has a 3.5 inch display may view all the flights arriving Atlanta airport using a combination of the airline algorithm as shown in paragraph [0070] and the spacing algorithm as shown in paragraph [0071]. The user may watch successive views of flights. When one of the views includes a flight of interest, the user may then tap the display or press a specified key to freeze the view (at least temporarily) and then select the flight of interest to see detailed information on the selected flight.

In a further embodiment the user may alter the criteria for the continuous and repetitive display and the amount of information displayed. For example, if the display is providing views according to Example 4, the user may alter the local configuration to provide views as in Example 5.

In a further embodiment the user may alter the display for convenience, say to remove one of the viewing elements. For example, to allow for more room for viewing the map, the user may temporarily remove the airline legend, list and clock.

What is claimed is:

1. A computer-based method of displaying real time flight information for aircraft, the method comprising:
retrieving data previously stored for which there is real time flight information; and
using such data to cause display, on a screen of a client computing device, automatically and repetitively of a plurality of views of a geographic map, each view overlaid with a group of icons corresponding to a group of a plurality of flights in a pre-specified category for which there is real time flight information, the locations of the icons on the map corresponding to locations for such flights based on real time flight information, each view associated with a distinct criterion for display of flights therein;
wherein the pre-specified category is associated with a flight attribute or a geographic area in which such flights are present;
such views collectively displaying all viewable flights in the pre-specified category.

2. A method according to claim 1, further comprising:
causing display simultaneously on the screen of the client computing device, with the geographic map, of a list of flights in the pre-specified category, such list scrolling automatically at least to the extent necessary to cause repetitive display of the entire list, wherein contents of the list are coordinated with each of the views.

3. A method according to claim 2, wherein each icon in the set of icons includes at least one of an airline abbreviation and an airline logo, the method further comprising:
causing display simultaneously on the screen of the client computing device, with the geographic map and the list, of a legend correlating airline name with at least one of airline abbreviation and airline logo.

4. A method according to claim 1, wherein each of the set of icons includes a textual component, and wherein causing display of the map overlaid with the set of icons includes placing each of the textual components on the map in such a way as to at least usually avoid obscuring any other of the textual components.

5. A method according to claim 2, wherein causing display of the list of flights pertinent to the area includes displaying flights in progress in the area.

6. A method according to claim 2, wherein causing display of the list of flights pertinent to the area includes displaying flights that have recently landed.

7. A method according to claim 2, wherein causing display of the list of flights pertinent to the area includes displaying scheduled flights that are not yet in air.

8. A method according to claim 1, further comprising:
causing the map to be displayed automatically and repetitively among a plurality of views so as to repetitively cover a plurality of geographic regions, the views collectively displaying all flights in progress in the geographic regions.

9. A method according to claim 8, wherein a plurality of airlines have flights arriving at an airport, and wherein causing the map to be displayed automatically and repetitively among a plurality of views includes causing the map to cycle through successive views, with each view relating to a distinct group of airlines having flights arriving at the airport.

10. A method according to claim 8, wherein causing the map to be displayed automatically and repetitively among a plurality of views includes causing the map to cycle through successive views associated with distinct facilities.

11. A method according to claim 8, wherein the distinct facilities are selected from the group consisting of airports and terminals.

12. A method according to claim 8, wherein causing the map to be displayed automatically and repetitively among a plurality of views includes causing at least one of zooming or panning of the map.

13. A method according to claim 12, wherein causing the map to be displayed automatically and repetitively among a plurality of views includes causing both zooming and panning of the map.

14. A method according to claim 2, wherein causing display of the list includes changing the contents of the list synchronously with views of the map so that flights for which icons are shown on a view of the map simultaneously appear on the list.

15. A method according to claim 2, wherein the list includes all flights in progress arriving at an airport.

16. A method according to claim 2, wherein the list includes all flights in progress of a plurality of airlines having flights arriving at an airport.

17. A method according to claim 15, wherein the list is sorted by airline, the list arranged so that the list scrolls automatically through the arriving flights of a first airline before scrolling through any of the arriving flights of another airline.

18. A method according to claim 2, wherein the list includes flights in progress arriving at a plurality of locations, the list arranged so that the list scrolls automatically through the arriving flights of a first location before scrolling through any of the arriving flights of another location.

19. A method according to claim 18, wherein each of the locations is a distinct terminal of an airport.

20. A method according to claim 18, wherein each of the locations is a distinct airport, and the airports are located near one another.

21. A method according to claim 2, wherein the list includes flights arriving at a terminal of an airport.

22. A method according to claim 1, further comprising;
in response to a user input to the client computing device as to a desired criterion in display of flight information, using the criterion in causing display of flight information.

23. A method according to claim 22 wherein the user input is an interrupt command, operative on the display automatically and repetitively of the plurality of views, and using the criterion includes freezing a selected view being displayed.

24. A method according to claim 23, further comprising:
providing a user input for selecting a flight of interest, and in response to the user input selecting a flight of interest, causing display of details concerning the flight of interest.

25. A method according to claim 24, wherein the user input for selecting the flight of interest also provides the interrupt command.

26. A method according to claim 1, further comprising:
causing display of at least one of an advertisement and a notification on the screen of the client computing device simultaneously with display of the geographic map.

27. A computerized method of placing AcID tags on a map in a graphical output, such map displaying corresponding icons representing aircraft in flight, the method comprising:
retrieving data previously stored for which there is real time flight information, such data pertinent to flight data to be displayed on the map;
processing the retrieved data to identify icon locations for placement of aircraft icons on the map corresponding to positions of the aircraft;
further processing the retrieved data to identify tag locations for placement of AcID tags on the map, wherein each tag location for an aircraft is defined by using the aircraft's target airport as a reference; and
providing a graphical output using the icon locations and the tag locations.

28. A method according to claim 27, wherein further processing includes assigning each such tag location to a primary position when available that is proximate to the corresponding icon and also generally aligned with a radial line running from the target airport through the corresponding icon.

29. A method according to claim 28, wherein the primary position is radially outside of the position of the corresponding icon with respect to the target airport.

30. A method according to claim 28, wherein, when the primary position is not available for a selected tag, further processing includes assigning the selected tag location to a secondary position that is incrementally angularly displaced about the corresponding icon location from the primary position.

31. A computerized method of representing flight delay status on a map in a graphical output, such map displaying icons representing aircraft in flight, the method comprising:
retrieving data previously stored for which there is real time flight information, such data pertinent to flight data to be displayed on the map;
processing the retrieved data to identify icon locations for placement at least of aircraft icons on the map corresponding to positions of the aircraft;
further processing the retrieved data to associate with each aircraft a visual characteristic, of at least one of its icon and its AcID tag, that is indicative of delay status of the flight; and
providing a graphical output using the icon locations and the visual characteristic.

32. A method according to claim 31, wherein the icon characteristic is color.

33. A method according to claim 32, wherein a first color of any icon indicates that the flight to which the icon corresponds is delayed and a second color of the icon indicates that the flight to which the icon corresponds is on time.

34. A method according to claim 33, wherein visual appearance of the icon is modified according to the extent by which the flight to which the icon corresponds is delayed.
